(19) United States
(12) Patent Application Publication
(10) Pub. No.: US 2002/0061970 A1
(43) Pub. Date: May 23, 2002

(54) Resin composition for coating material

(76) Inventor: Hidenori Sawada, Hiratsuka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/950,588

(22) Filed: Sep. 13, 2001

(30) Foreign Application Priority Data
Sep. 14, 2000 (JP) 2000-280010

(51) Int. Cl. C08F 8/00

(52) U.S. Cl. 525/107

(57) ABSTRACT

The present invention provides a resin composition for a coating material comprising an epoxy-modified polyurethane resin (A) obtained by reacting a carboxyl group-containing polyurethanepolyol obtained by reacting an isocyanate compound (a) and a polyol (b) with a hydroxycarboxylic acid (c) with an epoxy compound (d) in such a proportion that the epoxy group falls in a range of 0.1 to 1 equivalent per equivalent of the carboxyl group and a curing agent (B).

The present invention relates to a resin composition for a coating material comprising an epoxy-modified polyurethane resin capable of forming a protective coating film which is excellent in a water resistance, a solvent resistance and an adhesive property.

A polyurethane resin is excellent in physical properties such as toughness, an adhesive property and an impact resistance and therefore has so far widely been used in the respective fields such as coating materials, adhesives, inks and the like. In particular, in coating material use, it is widely employed for coating an interior and an exterior in buildings, bridges, ships, vehicles and the like.

However, a skeleton of the above resin is repetition of a carbon-carbon bond, a urethane bond and a urea bond and comprises a structure in which a cross-linking functional group is present only at an end of the resin skeleton. When it is used as a resin for a coating material, a cross-linking molecular weight of a cured coating film obtained by reacting it with a curing agent tends to grow large, and therefore there is the problem that the coating film performances such as a water resistance, a solvent resistance and a chemical resistance are not satisfactory.

On the other hand, disclosed in Japanese Patent Application Laid-Open No. 261420/1992 is a water based polyurethane resin composition comprising a product obtained by reacting a water based polyurethane resin having a carboxyl group in a molecule and an epoxy compound having two or more epoxy groups in a molecule. This resin composition is used as a cold drying type coating material in which a curing agent is not used in combination, and a coating film thereof shows an improved resistance against solvents, salt spraying and water. However, the coating film is not cross-linked, and therefore these coating film performances are not sufficiently satisfactory. Or, even if a curing agent is used in combination, the cross-linking property is unsatisfactory, and therefore involved is the problem that the coating film which is excellent in a corrosion resistance and a water resistance over a long period time can not be formed.

Intensive investigations repeated by the present inventors in order to solve the problems described above which are involved in conventional polyurethane resins have resulted in finding that the problems described above can be solved by using as a coating film-forming component, a specific epoxy-modified polyurethane resin having a secondary hydroxyl group which is obtained by reacting a carboxyl group-containing polyurethanepolyol with an epoxy compound, and thus they have come to complete the present invention.

Thus, the present invention provides a resin composition for a coating material comprising an epoxy-modified polyurethane resin (A) obtained by reacting a carboxyl group-containing polyurethanepolyol resin obtained by reacting an isocyanate compound (a) and a polyol (b) with a hydroxycarboxylic acid (c) with an epoxy compound (d) in such a proportion that the epoxy group falls in a range of 0.1 to 1 equivalent per equivalent of the carboxyl group and a curing agent (B).

The resin composition for a coating material of the present invention shall be explained below in further details.

The epoxy-modified polyurethane resin (A) used in the present invention is obtained by reacting the carboxyl group-containing polyurethanepolyol obtained by reacting the isocyanate compound (a) and the polyol (b) with the hydroxycarboxylic acid (c) with the epoxy compound (d).

Isocyanate Compound (a)

The isocyanate compound (a) constituting the carboxyl group-containing polyurethanepolyol includes aliphatic, alicyclic or aromatic compounds each having at least two isocyanate groups in a molecule. To be specific, it includes, for example, aliphatic diisocyanate compounds such as trimethylenediisocyanate, tetramethylenediisocyanate, 2,2,4-trimethylhexane-diisocyanate, hexamethylenediisocyanate, lysine-diisocyanate and dimeric acid diisocyanate; alicyclic diisocyanate compounds such as isophoronediisocyanate, 1,4-cyclohexylenediisocyanate, 4,4′-dicyclohexylmethane-diisocyanate, methylcyclohexanediisocyanate and cyclopentanediisocyanate; aromatic diisocyanate compounds such as 2,4-tolylenediisocyanate, 2,6-tolylene-diisocyanate, 4,4′-diphenylmethanediisocyanate, m-phenylenediisocyanate, xylylenediisocyanate, 3,3′-dimethyl-4,4′-biphenylenediisocyanate, 3,3′-dimethoxy-4,4′-biphenylenediisocyanate, 3,3′-dichloro-4,4′-biphenylenediisocyanate, 1,5-naphthalenediisocyanate, 1,5-tetrahydronaphthalenediisocyanate and toluidine-diisocyanate; polyisocyanate compounds obtained by linking a part of the isocyanate groups of these respective diisocyanate compounds with polyhydric alcohols, low molecular eight polyester resins and water; and cyclopolymerization products of the preceding respective diisocyanate compounds themselves and isocyanate.buret products.

Among these isocyanate compounds, suited are aliphatic diisocyanate compounds or alicyclic diisocyanate compounds such as hexamethylenediisocyanate and isophoronediisocyanate.

Polyol (b)

The polyol (b) used as a polyol component for reacting with the isocyanate compound (a) described above to form polyurethanepolyol includes low molecular weight glycols, high molecular weight glycols, polyesterpolyols and polycarbonatepolyols. They each can be used alone or may be used in combination of two or more kinds thereof. Suited as the polyol (b) are polyols, particularly diols having a number average molecular weight falling in a range of usually 62 to 10,000, particularly 100 to 4,000.

The low molecular weight glycols described above include, for example, ethylene glycol, diethylene glycol, triethylene glycol, 1,2-propylene glycol, 1,3-butylene glycol, neopentyl glycol, tetramethylene glycol, hexamethylene glycol, decamethylene glycol, octanediol, tricyclodecanedimethylol, hydrogenated bisphenol A, cyclohexanedimethanol, bisphenol A type polyethylene glycol ether and bisphenol A type polypropylene glycol ether. They each can be used alone or in combination of two or more kinds thereof.

The high molecular weight glycols described above include, for example, polyethylene glycol, polypropylene glycol and polytetramethylene glycol. The polyesterpolyols described above include, for example, products obtained by reacting glycol components with dicarboxylic acid components by conventionally known methods such as, for example, esterification reaction and transesterification reaction. Further, they include polyesterdiols obtained by ring-opening reaction of cyclic ester compounds such as ε-caprolactone and co-polycondensed polyesters thereof.

In the present invention, in order to elevate the physical properties of the coating film, dihydric alcohol can be used as the polyol (b) in combination with trihydric or higher alcohol. The trihydric or higher alcohol includes, for example, glycerin, trimethylolpropane, trimethylolethane, diglycerin, triglycerin, 1,2,6-hexanetriol, pentaerythritol and dipentaerythritol.

Hydroxycarboxylic Acid (c)

In the present invention, in order to introduce a carboxyl group into the polyurethanepolyol formed by reacting the isocyanate compound (a) described above with the polyol (b), the isocyanate compound (a) is reacted with the polyol (b) and the hydroxycarboxylic acid (c).

The hydroxycarboxylic acid (c) is a compound having at least one, preferably 1 or 2 hydroxyl groups and at least one, preferably one carboxyl group in a molecule. To be specific, it includes 2,2-dimethylolpropionic acid, 2,2-dimethylolbutyric acid, 2,2-dimethylolvaleric acid, hydroxypivalic acid, hydroxyisobutyric acid and polyesterlpolyols or polyetherpolyols obtained by condensing them.

Carboxyl Group-containing Polyurethanepolyol

In the present invention, the carboxyl group-containing polyurethanepolyol is produced by reacting the isocyanate compound (a), the polyol (b) and the hydroxycarboxylic acid (c) each described above.

The isocyanate compound (a), the polyol (b) and the hydroxycarboxylic acid (c) can be reacted at a temperature of usually about 40 to about 180° C., preferably about 60 to about 130° C. according to a conventionally known method, if necessary, in an organic solvent which is inert to an isocyanate group, such as, for example, dioxane, acetone, methyl ethyl ketone, methyl isobutyl ketone, N-methylpyrrolidone, tetrahydrofuran, toluene and xylene, if necessary, in the presence of a urethane catalyst such as, for example, an amine base catalyst including triethylamine, N-ethylmorpholine and triethylenediamine and a tin base catalyst including dibutyltin dilaurate and dioctyltin dilaurate. The solvent may be removed, if necessary, after finishing the reaction.

A use proportion of the isocyanate compound (a), the polyol (b) and the hydroxycarboxylic acid (c) in the reaction described above is selected so that the resulting polyurethane molecule has a hydroxyl group at an end thereof To be specific, an equivalent ratio of an isocyanate group to a hydroxyl group in these three components falls preferably in a range of usually 1:1 to 1:3, particularly 1:1 to 1:2.

The carboxyl group-containing polyurethanepolyol which is produced in the manner described above does not substantially contain a free isocyanate group and can have a number average molecular weight failing in a range of usually 600 to 30,000, preferably 1,000 to 10,000. Further, it suitably has an acid value falling in a range of usually 5 to 150 mg KOH/g, particularly 10 to 120 mg KOH/g and a hydroxyl group value falling in a range of usually 10 to 330 mg KOH/g, particularly 15 to 220 mg KOH/g, based on the resin solid matter.

Epoxy Compound (d)

In the present invention, the epoxy compound (d) is reacted with a carboxyl group contained in the carboxyl group-containing polyurethanepolyol which is obtained in the manner described above, whereby a secondary hydroxy group is introduced into the above polyurethanepolyol molecule. This secondary hydroxy group is useful for elevating an adhesive property between a coating film formed by the resin composition of the present invention and a coated face and/or reacting with a curing agent described later to elevate a cross-linking property of the coating film obtained from the resin composition of the present invention.

A compound having one or two epoxy groups in a molecule can suitably be used as the epoxy compound (d), and a monoepoxy compound includes, for example, alkylene oxides such as ethylene oxide, propylene oxide1, 1,2-butylene oxide, 1,2-pentylene oxide, 1,2-octylene oxide and dodecene oxide; aromatic oxides such as styrene oxide; glycidyl ethers such as glycidyl acetate, glycidyl laurate and “CARDURA E10” (glycidyl ester of versatic acid which is a higher fatty acid, manufactured by Shell Chemical Co., Ltd.); glycidyl ethers such as butyl glycidyl ether, octyl glycidyl ether, phenyl glycidyl ether and p-t-butylphenyl glycidyl ether; and epichlorohydrin. Further, a diepoxy compound includes, for example, (poly)ethylene glycol diglycidyl ether, (poly)propylene glycol diglycidyl ether, 1,4-butanediol diglycidyl ether, neopentyl glycol diglycidyl ether, 1,6-hexanediol diglycidyl ether, glycerin diglycidyl ether, butadiene dioxide, bisphenol A type epoxy resins, bisphenol F type epoxy resins, bisphenol AD type epoxy resins, hydrogenated bisphenol A type epoxy resins and hydrogenated bisphenol F type epoxy resins.

Among them, bisphenol A type epoxy resins, phenyl glycidyl ether and 1,6-hexanediol diglycidyl ether are particularly suited since the coating film finally obtained is excellent in an adhesive property and a water resistance. Especially, the bisphenol A type epoxy resins are suited.

Epoxy-modified Polyurethane Resin (A)

According to the present invention, the intended epoxy-modified polyurethane resin (A) can be obtained by esterification reaction between a carboxyl group contained in the carboxyl group-containing polyurethanepolyol described above and an epoxy group of the epoxy compound (d) described above.

The reaction of the carboxyl group-containing polyurethanepolyol with the epoxy compound (d) can be carried out at a temperature of about 100 to about 180° C., preferably about 120 to about 160° C., if necessary, in the presence of a catalyst accelerating esterification reaction including ammonium salts such as tetraethylammonium bromide and tetrabutylammonium bromide; tin compounds such as dibutyltin dilaurate; and lithium halides.

In the reaction described above, the epoxy compound (d) can be used in a proportion falling in a range of usually 0.1 to 1 equivalent per equivalent of a carboxyl group contained in the above carboxyl group-containing polyurethanepolyol.

The epoxy-modified polyurethane resin (A) can be used for coating materials of various forms such as a solvent base and a water base. When the resin (A) described above is used in the solvent base, the epoxy compound (d) is used in such a proportion that an epoxy group falls in a range of 0.4 to 1.0 equivalent per equivalent of a carboxyl group since a water resistance and an adhesive property of the resulting coating film can be maintained well.

On the other hand, when the epoxy-modified polyurethane resin (A) is used in the water base, it is essential to allow a carboxyl group which is a water dispersible group for making the above resin (A) water-dispersible or water-soluble to remain, and the epoxy compound (d) is suitably used in such a proportion that an epoxy group falls in a range of particularly 0.1 to 0.9 equivalent, further particularly 0.2 to 0.8 equivalent per equivalent of a carboxyl group.

Water dispersion or water solubilization of the epoxy-modified polyurethane resin (A) can be carried out by a conventionally known method, and it can be carried out, for example, by adding the above resin (A) in one lot or gradually to an aqueous solution containing, if necessary, a neutralizing agent and a surfactant while stirring to mix and disperse them. The neutralizing agent which can be used in this case shall not specifically be restricted as long as it can neutralize a carboxyl group and includes, for example, sodium hydroxide, potassium hydroxide, trimethylamine, diemthylaminoethanol, 2-methyl-2-amino-1-propanol, triethylamine and aqueous ammonia. The neutralizing agent may be added in advance to the resin to neutralize a carboxyl group or may be added to water which is a dispersant to neutralize a carboxyl group at the same time as dispersion of the resin A use amount thereof resides preferably in a proportion falling in a range of usually 0.2 to 1.2 equivalent, preferably 0.3 to 0.8 equivalent per equivalent of a carboxyl group.

The epoxy-modified polyurethane resin (A) produced in the manner described above has both of a primary hydroxyl group originating in the carboxyl group-containing polyurethanepolyol described above and a secondary hydroxyl group formed by reaction of the carboxyl group-containing polyurethanepolyol with the epoxy compound (d). A primary hydroxyl group of the above resin (A) falls suitably in a range of usually 5 to 300 mg KOH/g, preferably 10 to 200 mg KOH/g based on the resin solid matter, and a secondary hydroxyl group of the above resin (A) falls suitably in a range of usually 5 to 150 mg KOH/g, preferably 10 to 100 mg KOH/g based on the resin solid matter.

Further, the epoxy-modified polyurethane resin (A) can have a weight average molecular weight falling in a range of usually 5,000 to 200,000, preferably 10,000 to 100,000.

Curing Agent (B)

The resin composition for a coating material of the present invention comprises the curing agent (B) for curing and cross-linking the epoxy-modified polyurethane resin (A) described above.

Any ones can be used as the curing agent (B) which can be blended with the resin composition of the present invention without any restrictions as long as they can be reacted with at least a primary hydroxyl group contained in the above resin (A). Among them, suited are melamine curing agents and blocked isocyanate curing agents which have an excellent reactivity with a primary hydroxyl group.

The melamine curing agents include methylol melamine resins obtained by reacting melamine with aldehydes such as formaldehyde, paraformaldehyde, acetaldehyde and benzaldehyde. Further, capable of being used as well are methylol melamine resins in which a part or all of the methylol groups is etherified with at least one alcohol. Examples of the alcohols used for the etherification include monohydric alcohols such as methyl alcohol ethyl alcohol n-propyl alcohol, isopropyl alcohol n-butyl alcohol isobutyl alcohol, 2-ethylbutanol and 2-ethylhexnol. Among them, suited are melamine resins obtained by etherifying at least a part of the methylol groups of the methylol melamine resins with monohydric alcohols having 1 to 4 carbon atoms.

A blending amount of the melamine curing agent described above shall not strictly be restricted and can fall in a range of usually 95/5 to 50/50, preferably 90/10 to 60/40 in terms of a weight ratio of the epoxy-modified urethane resin (A)/the melamine curing agent.

When the melamine curing agent described above is used, a curing-accelerating catalyst including, for example, acid catalysts such as paratoluenesulfonic acid, dodecylbenzenesulfonic acid, di-nonylnaphthalene-sulfonic acid and phosphoric acid or amine-neutralized products of these acids can be blended with the resin composition of the present invention in order to further accelerate the curing reaction.

The blocked isocyanate curing agent is obtained by subjecting an isocyanate group of the isocyanate compound to addition reaction with a blocking agent, and the above isocyanate compound includes the compounds which have been given as the examples of the isocyanate compound (a) and end isocyanate-containing compounds obtained by reacting these isocyanate compounds with active hydrogen-containing low molecular compounds such as ethylene glycol propylene glycol trimethylolpropane, hexanetriol and castor oil.

On the other hand, the blocking agent is added to an isocyanate group of the isocyanate compound to block temporarily the above isocyanate group. A blocked isocyanate compound produced by the addition is preferably a compound which is stable at a room temperature but preferably dissociates the blocking agent when heated to a baking temperature of the coating film, for example, a temperature of about 100 to about 200° C., whereby a free isocyanate group can be reproduced. Capable of being given as examples of the blocking agent satisfying such condition are, for example, lactam base compounds such as ε-caprolactam and γ-caprolactam; oxime base compounds such as methyl ethyl ketoxime and cyclohexanone oxime; phenol base compounds such as phenol p-t-butylphenol and cresol; aliphatic alcohols such as n-butanol and 2-ethylhexanol; aromatic alkyl alcohols such as phenylcarbitol and methylphenylcarbitol; and ether alcohol base compounds such as ethylene glycol monobutyl ether.

A blending amount of the blocked isocyanate curing agent described above shall not strictly be restricted as well, and an isocyanate group reproduced from the above blocked isocyanate compound falls suitably in a range of 0.1 to 1.5 equivalent, particularly 0.3 to 1 equivalent per equivalent of a hydroxyl group contained in the resin (A).

In the resin composition of the present invention, when the blocked isocyanate curing agent is used, a tin compound can be contained as a dissociating catalyst for the blocking agent or a curing catalyst. The above tin compound includes, for example, organic tin compounds such as dibutyltin oxide and dioctyltin oxide; and aliphatic or aromatic carboxylic acid salts of dialkyltin such as dibutyltin dilaurate, dioctyltin dilaurate, dibutyltin diacetate, dioctyltin benzoateoxy, dibutyltin benzoateoxy, dioctyltin dibenzoate and dibutyltin dibenzoate.

Resin Composition for Coating Material

The resin composition of the present invention comprises the epoxy-modified polyurethane resin (A) and the curing agent (B) and can be used as a coating film-forming component in a clear coating material and an enamel coating material.

In preparing the coating material, resins having functional groups such as a hydroxyl group and a carboxyl group, for example, resins for modification such as an acryl resin and a polyester resin and additives for a coating material such as pigments, fillers, aggregates, pigment dispersants, wetting agents, defoaming agents, plasticizers, organic solvents, preservatives, anti-mould agent, pH controllers, rust preventives and leveling agents can suitably be selected according to the respective purposes, combined and blended with the resin composition of the present invention.

A coating material comprising the resin composition of the present invention can be coated by a conventionally known method, and in the case of a water base coating material, it can be electrodepositably coated. To be specific, a paste prepared by dispersing, if necessary, a pigment and the like and purified water are added to a water dispersion of a composition comprising the epoxy-modified polyurethane resin (A) and the curing agent (B) to control the solid content in a range of usually 10 to 30% by weight, preferably 15 to 25% by weight, and the organic solvent and water are partially vaporized at a temperature of about 25 to 35° C., preferably 28 to 32° C. while stirring to prepare an electrodepositable coating bath. An article to be coated can be dipped therein as an anode to carry out electrodepositable coating. Then, the article to be coated is pulled up from the electrodepositable coating bath and washed with water, and then it is baked at a temperature falling in a range of usually about 100 to about 200° C., preferably about 120 to about 180° C. for 10 to 60 minutes, whereby a cured coating film can be obtained. The above cured coating film has a film thickness falling suitably in a range of usually 5 to 100 μm, particularly 10 to 40 μm.

The present invention shall more specifically be explained below with reference to examples and comparative examples. In the examples, “parts” and “%” mean “parts by weight” and “% by weight” unless otherwise described.

Production of Epoxy-modified Polyurethane Resins

### EXAMPLE 1

A reaction vessel equipped with a thermometer, a thermostat, a stirrer, a reflux condenser and a dropping device was charged with 200 parts of methyl isobutyl ketone, 600 parts of polypropylene glycol (average molecular weight: 1,000), 156 parts of neopentyl glycol and 222 parts of dimethylolbutyric acid and heated while stirring to raise the temperature up to 70° C. When the solution became homogeneous, 437 parts of hexamethylenediisocyanate was dropwise added in 60 minutes while maintaining the reaction temperature at 70° C. After finishing dropwise adding, the reaction temperature was elevated to 80° C., and the reaction was continued until the isocyanate group disappeared (until the isocyanate value became 0.2 mg NCO/g or less based on a solid content) to obtain urethanepolyol having a hydroxyl group at a terminal. Then, the reaction vessel was charged with 200 parts of ethylene glycol monobutyl ether, 266 parts of “Epikote 828EL” (remark 1) and 1.0 part of tetraethylammonium bromide as a reaction catalyst and heated to raise the temperature up to 140° C., and the reaction was continued until the epoxy value became about 0.07 millimole/g based on a solid content and the acid value became about 8.0 mg KOH/g based on a solid content. Then, the reaction vessel was charged with 504 parts of methyl isobutyl ketone while cooling to obtain an epoxy-modified polyurethane resin solution (A-1) having a solid content of 65%.

(Remark 1): “Epikote 828EL”: manufactured by Japan Epoxy Resin Ltd., bisphenol A type epoxy resin, epoxy equivalent: about 190.

### EXAMPLES 2 to 10

The same procedure as in Example 1 was carried out to obtain epoxy-modified polyurethane resin solutions (A-2) to (A-10), except that the blend composition and the acid value in Example 1 were changed as shown in the following Table 1.

TABLE 1

| | | Example | | | | | | | | | |
|---|---|---|---|---|---|---|---|---|---|---|---|
| Epoxy-modified polyurethane resin composition | | 1 | 2 | 3 | 4 | 5 | 6 | 7 | 8 | 9 | 10 |
| Resin name | | A-1 | A-2 | A-3 | A-4 | A-5 | A-6 | A-7 | A-8 | A-9 | A-10 |
| Solvent | Methyl isobutyl ketone | 200 | 400 | 400 | 200 | 200 | 200 | 200 | 200 | 200 | 200 |
| Carboxyl | Polypropylene glycol | 600 | | 1200 | 600 | 600 | 600 | | 600 | | |
| group- | Neopentyl glycol | 156 | 416 | 395 | 104 | 156 | 156 | 20.8 | 156 | 104 | 156 |
| contain- | Polytetramethylene glycol | | 1200 | | | | | 600 | | | 600 |
| ing polyol | “PLACCEL 205” (remark 2) | | | | | | | | | 1056 | |
| composi- | Ethyl alcohol | | | | | | | | | | |
| tion | Dimethylolpropionic acid | | 134 | | 268 | 201 | | 268 | 201 | | |
| | Dimethylolbutyric acid | 222 | | | | | 222 | | | 296 | 296 |
| | Hydroxypivalic acid | | | 142 | | | | 94.4 | | | |
| | Hexamethylenediisocyanate | 437 | | 874 | 437 | 437 | 437 | | 437 | 672 | |
| | Isophoronediisocyanate | | 1154 | | | | | 577 | | | 688 |
| Solvent | Ethylene glycol butyl ether | 200 | 400 | 400 | 200 | 200 | 200 | 200 | 200 | 200 | 200 |
| Kind of | “Epikote 828EL” (remark 1) | 266 | 114 | 228 | | 152 | 76 | 304 | 114 | | 114 |
| epoxy | “Denacol EX212” (remark 3) | | | | 240 | | | | | 90 | |
| | Phenyl glycidyl ether | | | | | 75 | | | | | 60 |
| Catalyst | Tetraethylammonium bromide | 1.0 | 1.9 | 1.8 | 1.0 | 1.0 | 1.0 | 1.1 | 1.0 | 1.6 | 1.3 |
| Solvent | Methyl isobutyl ketone | 504 | 823 | 726 | 487 | 472 | 402 | 603 | 412 | 793 | 630 |

| | | | | | | | | | | |
|---|---|---|---|---|---|---|---|---|---|---|
| Acid value/mg KOH/g (measured) | 8.0 | 12.0 | 4.0 | 18.0 | 11.0 | 46.0 | 40.0 | 33.5 | 35.4 | 29.3 |
| Primary hydroxyl group value/mg KOH/g | 66.8 | 37.2 | 15.8 | 68.0 | 69.2 | 75.3 | 36.1 | 74.4 | 50.6 | 58.6 |
| Secondary hydroxyl group value/mg KOH/g | 46.7 | 11.2 | 23.7 | 54.4 | 45.0 | 15.1 | 48.1 | 22.3 | 15.2 | 29.3 |
| Epoxy/acid equivalent ratio | 0.93 | 0.60 | 1.00 | 0.80 | 0.87 | 0.27 | 0.57 | 0.40 | 0.30 | 0.50 |
| Solid content/% | 65.0 | 65.0 | 65.0 | 65.0 | 65.0 | 65.0 | 65.0 | 65.0 | 65.0 | 65.0 |

(Remark 2) “PLACCEL 205”: manufactured by Daicel Chemical Industries Ltd., polycaprolactonediol, average molecular weight: 528.

(Remark 3) “Denacol EX212”: manufactured by Nagase Chemicals Ltd., 1.6-hexanediol diglycidyl ether, epoxy equivalent: about 300.

Production of Polyurethane Resins which are not Modified with Epoxy Compound

### Comparative Example 1

A reaction vessel equipped with a thermometer, a thermostat, a stirrer, a reflux condenser and a dropping device was charged with 200 parts of methyl isobutyl ketone, 600 parts of polypropylene glycol (average molecular weight: 1,000), 302 parts of neopentyl glycol and 13.4 parts of dimethylolpropionic acid and heated while stirring to raise the temperature up to 70° C. When the solution became homogeneous, 437 parts of hexamethylenediisocyanate was dropwise added in 60 minutes while maintaining the reaction temperature at 70° C. After finishing dropwise adding, the reaction temperature was elevated to 80° C. to continue the reaction until the isocyanate group disappeared (until the isocyanate value became 0.2 mg NCO/g or less based on a solid content). Then, the reaction vessel was charged with 200 parts of ethylene glycol monobutyl ether and charged with 328 parts of methyl isobutyl ketone while cooling to obtain a polyurethane resin solution (A-11) having a solid content of 65% and an acid value of 4.2 mg KOH/g based on a solid content. This resin had a primary hydroxyl group value of 83.0 mg KOH/g based on a solid content.

### Comparative Example 2

A reaction vessel equipped with a thermometer, a thermostat, a stirrer, a reflux condenser and a dropping device was charged with 200 parts of methyl isobutyl ketone, 600 parts of polytetramethylene glycol (average molecular weight: 1,000), 208 parts of neopentyl glycol and 148 parts of dimethylolbutyric acid and heated while stirring to raise the temperature up to 70° C. When the solution became homogeneous, 437 parts of hexamethylenediisocyanate was dropwise added in 60 minutes while maintaining the reaction temperature at 70° C. After finishing dropwise adding, the temperature was elevated to 80° C. to continue the reaction until the isocyanate group disappeared (until the isocyanate value became 0.2 mg NCO/g or less based on a solid content). Then, the reaction vessel was charged with 200 parts of ethylene glycol monobutyl ether and charged with 350 parts of methyl isobutyl ketone while cooling to obtain a polyurethane resin solution (A-12) having a solid content of 65% and an acid value of 40.3 mg KOH/g based on a solid content. This resin had a primary hydroxyl group value of 80.6 mg KOH/g.

### Comparative Example 3

A reaction vessel equipped with a thermometer, a thermostat, a stirrer, a reflux condenser and a dropping device was charged with 200 parts of methyl isobutyl ketone, 600 parts of polypropylene glycol (average molecular weight: 1,000), 156 parts of neopentyl glycol and 134 parts of dimethylolpropionic acid and heated while stirring to raise the temperature up to 70° C. When the solution became homogeneous, 353 parts of hexamethylenediisocyanate was dropwise added in 60 minutes while maintaining the reaction temperature at 70° C. After finishing dropwise adding, the temperature was elevated to 80° C. to continue the reaction until the isocyanate group disappeared (until the isocyanate value became 0.2 mg NCO/g or less based on a solid content). Then, the reaction vessel was charged with 200 parts of ethylene glycol monobutyl ether and charged with 269 parts of methyl isobutyl ketone while cooling to obtain a polyurethane resin solution (A-13) having a solid content of 65% and an acid value of 45.1 mg KOHIg based on a solid content. This resin had a primary hydroxyl group value of 90.3 mg KOH/g.

Production of Epoxy-modified Polyurethane Resins Having No Primary Hydroxyl Group

### Comparative Example 4

A reaction vessel equipped with a thermometer, a thermostat, a stirrer, a reflux condenser and a dropping device was charged with 200 parts of methyl isobutyl ketone, 600 parts of polytetramethylene glycol (average molecular weight: 1,000) and 148 parts of dimethylolbutyric acid and heated while stirring to raise the temperature up to 70° C. When the solution became homogeneous, 577 parts of isophoronediisocyanate was dropwise added in 30 minutes while maintaining the reaction temperature at 70° C. After finishing drop-wise adding, the temperature was elevated to 80° C. to continue the reaction until the isocyanate value became about 65.0 mg NCO/g based on a solid content. Further, the reaction vessel was charged with 92 parts of ethyl alcohol, and the reaction was continued at 80° C. until the isocyanate group disappeared (until the isocyanate value became 0.2 mg NCO/g or less based on a solid content) to obtain polyurethane having no hydroxyl group at a terminal. Then, the reaction vessel was charged with 200 parts of ethylene glycol monobutyl ether, 152 parts of “Epikote 828EL” (remark 1) and 1.0 part of tetraethylammonium bromide and heated to raise the temperature up to 140° C., and the reaction was continued until the epoxy value became about 0.07 millimole/g based on a solid content and the acid value became about 12.0 mg KOH/g based on a solid content. Then, the reaction vessel was charged with 444 parts of methyl isobutyl ketone while cooling to obtain an epoxy-modified polyurethane resin solution (A-14) having a solid content of 65% and no primary hydroxyl group. This resin had a secondary hydroxyl group value of 28.6 mg KOH/g based on a solid content.

### Comparative Example 5

A reaction vessel equipped with a thermometer, a thermostat, a stirrer, a reflux condenser and a dropping device was charged with 200 parts of methyl isobutyl ketone, 600 parts of polytetramethylene glycol (average molecular weight: 1,000) and 266 parts of dimethylolbutyric acid and heated while stirring to raise the temperature up to 70° C. When the solution became homogeneous, 755 parts of isophoronediisocyanate was dropwise added in 30 minutes while maintaining the reaction temperature at 70° C. After finishing drop-wise adding, the temperature was elevated to 80° C. to continue the reaction until the isocyanate value became about 55.0 mg NCO/g based on a solid content. Further, the reaction vessel was charged with 92 parts of ethyl alcohol, and the reaction was continued at 80° C. until the isocyanate group disappeared (until the isocyanate value became 0.2 mg NCO/g or less based on a solid content) to obtain polyurethane having no hydroxyl group at a terminal. Then, the reaction vessel was charged with 200 parts of ethylene glycol monobutyl ether, 114 parts of “Epikote 828EL” (remark 1) and 1.1 part of tetraethylammonium bromide and heated to raise the temperature up to 140° C., and the reaction was continued until the epoxy value became about 0.07 millimole/g based on a solid content and the acid value became about 41.0 mg KOH/g based on a solid content. Then, the reaction vessel was charged with 583 parts of methyl isobutyl ketone while cooling to obtain an epoxy-modified polyurethane resin solution (A-15) having a solid content of 65% and no primary hydroxyl group. This resin had a secondary hydroxyl group value of 18.4 mg KOH/g based on a solid content.

### Comparative Example 6

A reaction vessel equipped with a thermometer, a thermostat, a stirrer, a reflux condenser and a dropping device was charged with 34.3 parts of N-methylpyrrolidone, 83.7 parts of polytetramethylene glycol (average molecular weight: 2,000), 51.6 parts of neopentyl glycol 4.2 parts of trimethylolpropane and 21.5 parts of dimethylolpropionic acid, stirred while introducing nitrogen and heated to raise the temperature up to 90° C. When the solution became homogeneous, the solution was cooled down to 40° C. and diluted with 86 parts of acetone, and 139.0 parts of tolylenediisocyanate was dropwise added in 60 minutes while maintaining the reaction temperature at 30 to 40° C. After finishing dropwise adding, the reaction was continued as it was for 8 hours, and the solution was further diluted with 86 parts of acetone to obtain polyurethane having an isocyanate group at a terminal. Then, the reaction vessel was charged with 52.9 parts of “Epikote 1001” (remark 4) and mixed therewith. Another reaction vessel was charged with 12.1 parts of dimethylethanolamine and 481.5 parts of deionized water and heated up to 40° C. A mixture of 506.4 parts of the polyurethane described above and 52.9 parts of “Epikote 1001” was dropwise added, and acetone was removed at 40° C. under reduced pressure. Then, the reaction temperature was maintained at 70 to 80° C. to obtain a dispersion type epoxy-modified polyurethane resin aqueous dispersion (A-16) having a solid content of 40% and no primary hydroxyl group.

(Remark 4) “Epikote 1001”: manufactured by Yuka Shell Epoxy Co., Ltd., bisphenol A type epoxy resin, epoxy equivalent: about 500.

Production of Blocked Isocyanate Curing Agent

A reaction vessel equipped with a thermometer, a thermostat, a stirrer, a reflux condenser and a dropping device was charged with 90 parts of methyl isobutyl ketone and 222 parts of isophoronediisocyanate and heated to raise the temperature up to 50° C., and 183 parts of methyl ethyl ketoxime was dropwise added in about 2 hours. After finishing dropwise adding, the temperature was elevated to 70° C., and the reaction was continued until the isocyanate group disappeared (until the isocyanate value became 0.2 mg NCO/g or less based on a solid content) to obtain a blocked isocyanate curing agent (B-1) having a solid content of 80%.

Production of Solvent Base Coating Material Compositions

### EXAMPLE 11

Blended were 123 parts of the epoxy-modified polyurethane resin solution (A-1) obtained in Example 1, 20 parts of “Cymel 303” (remark 5) as a melamine curing agent, 0.1 part of dodecylbenzene-sulfonic acid, 20 parts of titan white and 20 parts of talc (extender pigment), and they were stirred for 30 to 60 minutes by means of a stirrer to disperse the pigment. Added thereto was 32 parts of propylene glycol monomethyl ether to obtain a solvent base coating material composition (C-1) having a solid content of 65%.

(Remark 5) “Cymel 303”: manufactured by Mitsui Cytec Ltd., methyl-etherified melamine, solid content: 100%.

### EXAMPLES 12 to 15

and

### Comparative Examples 7 to 9

The same procedure as in Example II was carried out to obtain solvent base coating material compositions (C-2) to (C-8), except that the blends and the composition were changed as shown in Table 2.

Coating Test

The respective solvent base coating material compositions obtained above were coated on a cold finished mild steel plate described in JIS G. 3141 in a dried film thickness of 30 micron by means of a bar coater and baked at 170° C. for 20 minutes in an electric hot air dryer to prepare test coated plates, and they were evaluated based on the following criteria. The results thereof are shown in Table 2.

Water Resistance

The respective coated test plates were immersed in warm water of 80° C. for 24 hours and pulled up, and then the surface conditions thereof were visually observed:

∘: nothing abnormal Δ: frosted, X: blister produced.

Olvent Resistance

The coated surfaces of the respective coated test plates were rubbed by 100 reciprocations with a gauze impregnated with various solvents shown in Table 2 to visually observe the surface conditions thereof:

∘: nothing abnormal, Δ: frosted, X: coating film dissolved.

Adhesive Property

Formed on the respective test plates by means of a cutter were 100 measures of 2 mm, and a cellophane pressure-sensitive tape was tightly adhered on the surfaces thereof and strongly peeled off. Then, the number of the cross cuts remaining on the costing film was checked:

∘: 100 cross cuts, Δ: 90 to 99 cross cuts, X: 89 or less cross cuts.

TABLE 2

| | | | Example | | | | | Comparative Example | | |
|---|---|---|---|---|---|---|---|---|---|---|
| Solvent base coating material composition | | | 11 | 12 | 13 | 14 | 15 | 7 | 8 | 9 |
| Coating material name | | | C-1 | C-2 | C-3 | C-4 | C-5 | C-6 | C-7 | C-8 |
| Compo- | Resin | Kind | A-1 | A-2 | A-3 | A-4 | A-5 | A-11 | A-11 | A-14 |
| sition | | Amount | 123 | 123 | 123 | 138 | 138 | 123 | 138 | 123 |
| | Melamine | “Cymel 303” (remark 5) | 20 | 20 | 20 | | | 20 | | 20 |
| | Blocked isocyanate | B-1 | | | | 12.5 | 12.5 | | 12.5 | |
| | Curing catalyst | Dodecylbenzene- | 0.1 | 0.1 | 0.1 | | | 0.1 | | 0.1 |
| | | sulfonic acid | | | | | | | | |
| | | Dibutyltin dilaurate | | | | 1.0 | 1.0 | | 1.0 | |
| | Pigment | Titan white | 20 | 20 | 20 | 20 | 20 | 20 | 20 | 20 |
| | | Talc | 20 | 20 | 20 | 20 | 20 | 20 | 20 | 20 |
| | Solvent | Propylene glycol mono | 32 | 32 | 32 | 24 | 24 | 32 | 24 | 32 |
| | | methyl ether | | | | | | | | |
| Coating material solid content % | | | 65 | 65 | 65 | 65 | 65 | 65 | 65 | 65 |
| Evalu- | Water resistance | | ◯ | ◯ | ◯ | ◯ | ◯ | X | X | X |
| ation | Solvent resistance | Xylene | ◯ | ◯ | ◯ | ◯ | ◯ | ◯ | ◯ | Δ |
| test | | Methyl ethyl ketone | ◯ | ◯ | ◯ | ◯ | ◯ | Δ | Δ | Δ |
| | | Ethanol | ◯ | ◯ | ◯ | ◯ | ◯ | Δ | Δ | Δ |
| | Adhesive property | | ◯ | ◯ | ◯ | ◯ | ◯ | Δ | Δ | Δ |

Production of Water Base Coating Material Compositions

### EXAMPLE 16

Mixed and stirred were 123 parts of the epoxy-modified polyurethane resin solution (A-6) having a solid content of 65% obtained in Example 6, 20 parts of “Cymel 303” (remark 5) as a melamine curing agent, 0.1 part of dodecylbenzenesulfonic acid as a curing catalyst and 4.8 parts of triethylamine as a neutralizing agent, and the mixed solution was added to 138 parts of deionized water and dispersed while stirring to obtain a water base resin composition having a solid content of 35%. Then, blended with 286 parts of the water base resin composition were 20 parts of titan white, 20 parts of talc, 1.2 part of “Nopcosperse 44C” (remark 6) and 0.6 part of “SN Defoamer 364” (remark 7). The mixture was stirred for 30 to 60 minutes by means of a stirrer to disperse the pigment, and 22 parts of deionized water was added thereto to obtain a water base coating material composition (D-9) having a solid content of 40%.

(Remark 6) “Nopcosperse 44C”: pigment dispersant, manufactured San Nopco Ltd.

(Remark 7) “SN Defoamer 364”: defoamer, manufactured by San Nopco Ltd.

### EXAMPLE 17

and

### Comparative Examples 10 to 13

The same procedure as in Example 16 was carried out to obtain water base coating material compositions (C-9) to (C-14), except that the blend composition in Example 1 was changed to those shown in the following Table 3.

Coating Evaluation

The respective water base coating material compositions obtained above were coated by the same method as in the solvent base coating material compositions described above and evaluated according to the same criteria. Further, a salt spray test was carried out. The results thereof are shown together in Table 3.

TABLE 3

| | | | Example | | Comparative Example | | | |
|---|---|---|---|---|---|---|---|---|
| Water base coating material composition | | | 16 | 17 | 10 | 11 | 12 | 13 |
| Coating material name | | | C-9 | C-10 | C-11 | C-12 | C-13 | C-14 |
| Compo- | Resin | Kind | A-6 | A-7 | A-12 | A-15 | A-16 | A-16 |
| sition | | Amount | 123 | 138 | 123 | 123 | 200 | 225 |
| | Melamine | “Cymel 303” | 20 | | 20 | 20 | 20 | |
| | Blocked isocyanate | B-1 | | 12.5 | | | | 12.5 |
| | Curing catalyst | Dodecylbenzene-sulfonic acid | 0.1 | | 0.1 | 0.1 | 0.1 | |
| | | Dibutyltin dilaurate | | 1.0 | | | | 1 |
| | Neutralizing agent | Triethylamine | 4.8 | 4.7 | 4.8 | 4.8 | | |
| | Deionized water | | 138 | 130 | 138 | 138 | 65.8 | 47.7 |
| | Pigment | Titan white | 20 | 20 | 20 | 20 | 20 | 20 |
| | | Talc | 20 | 20 | 20 | 20 | 20 | 20 |
| | Pigment | “Nopcosperse 44C” (remark 6) | 1.2 | 1.2 | 1.2 | 1.2 | 1.2 | 1.2 |
| | dispersant | | | | | | | |
| | Defoaming agent | “SN Defoamer 364” (remark 7) | 0.6 | 0.6 | 0.6 | 0.6 | 0.6 | 0.6 |
| | Deionized water | | 22 | 22 | 22 | 22 | 22 | 22 |
| Coating material solid content % | | | 40 | 40 | 40 | 40 | 40 | 40 |
| Evalua- | Water resistance | | ◯ | ◯ | X | X | Δ | Δ |
| tion | Solvent resistance | Xylene | ◯ | ◯ | ◯ | Δ | ◯ | ◯ |
| test | | Methyl ethyl ketone | ◯ | ◯ | Δ | Δ | ◯ | ◯ |
| | | Ethanol | ◯ | ◯ | Δ | Δ | ◯ | ◯ |
| | Adhesive property | | ◯ | ◯ | Δ | Δ | ◯ | ◯ |

| | | | | | | |
|---|---|---|---|---|---|---|
| Salt spray test (remark 8) | ◯ | ◯ | X | X | X | X |

(Remark 8) salt spray test: cross cuts were given to the coating films of the respective coated test plates so that they reached the base, and the test plates were subjected to a salt spray tester for 240 hours and then visually evaluated:

∘: nothing abnormal, X: rusts proceed from cut parts and are whitened.

Production of Anionically Electrodepositable Coating Material Compositions

Production of Pigment Paste for Anionically Electrodepositable Coating Material

Deionized water was added to 7.7 parts of the epoxy-modified polyurethane resin solution (A-6) obtained in Example 6, 25 parts of titan white and 0.37 part (1.0 equivalent neutralization) of triethylamine, and they were mixed and dispersed by means of a ball mill to obtain a pigment paste (P-1) for an anionically electrodepositable coating material having a solid content of 50%.

Production of Emulsion for Anionically Electrodepositable Coating Materials

### EXAMPLE 18

Mixed and stirred were 123 parts of the epoxy-modified polyurethane resin solution (A-6) in Example 6, 20 parts of a melamine curing agent ┌Cymel 303” (remark 5), 0.1 part of dodecylbenzenesulfonic acid and 2.9 parts of triethylamine, and the mixed solution was added to deionized water while stirring and dispersed to obtain an emulsion for an anionically electrodepositable coating material having a solid content of 30%. Added to 333 parts (solid matter 100 parts) of this emulsion for an anionically electrodepositable coating material was 60 parts (solid matter 30 parts) of the preceding pigment paste (P-1) for an anionically electrodepositable coating material having a solid content of 50%, and the mixture was diluted with deionized water to obtain an anionically electrodepositable coating material composition (C-15) having a solid content of 20%.

### EXAMPLES 19 to 22

and

Comparative Examples 14 to 18

The same procedure as in Example 18 was carried out to obtain anionically electrodepositable coating material compositions (C-16) to (C-24), except that the blend composition in Example 18 was changed to those shown in the following Table 4.

Electrodepositable Coating and Evaluation

A stainless steel-made cylindrical open can was charged with the respective anionically electrodepositable coating material compositions (C-15) to (C-24) obtained above to remove excessive solvents contained in the coating materials while stirring at a liquid temperature of 30° C. for 2 days in an open state. Then, the solid contents were controlled to 20% with deionized water, and the respective compositions were anionically electrodepositablly coated on a cold rolled steel plate (SPCC plate) so that the dried film thickness was about 20 μm. The electrodepositablly coated plates thus obtained were pulled up from the bath, washed with water and baked at 170° C. for 20 minutes in an electric hot air dryer to prepare coated test plates. The resulting coated test plates were evaluated by the same method and criteria as those described in the item of the water base coating material composition described above. The results thereof are shown in Table 4.

TABLE 4

| Anionically electrodepositable coating material | | | Example | | | | | Comparative Example | | | | |
|---|---|---|---|---|---|---|---|---|---|---|---|---|
| composition | | | 18 | 19 | 20 | 21 | 22 | 14 | 15 | 16 | 17 | 18 |
| Coating material name | | | C-15 | C-16 | C-17 | C-18 | C-19 | C-20 | C-21 | C-22 | C-23 | C-24 |
| Compo- | Resin | Kind | A-6 | A-8 | A-7 | A-9 | A-10 | A-13 | A-15 | A-16 | A-16 | A-16 |
| sition | | Amount | 123 | 123 | 138 | 123 | 138 | 123 | 138 | 200 | 225 | 250 |
| | Melamine | “Cymel 303” | 20 | 20 | | 20 | | 20 | | 20 | | |
| | Blocked isocyanate | B-1 | | | 12.5 | | 12.5 | | 12.5 | | 12.5 | |
| | Curing catalyst | Dodecylbenzene- | 0.1 | 0.1 | | 0.1 | | 0.1 | | 0.1 | | |
| | | sulfonic acid | | | | | | | | | | |
| | | Dibutyltin dilaurate | | | 1.0 | | 1.0 | | 1.0 | | 1 | |
| | Deionized water | | 187 | 187 | 179 | 187 | 179 | 187 | 179 | 112.9 | 94.9 | 83.4 |
| | Neutralizing agent | Triethylamine | 2.9 | 2.9 | 2.9 | 2.9 | 2.9 | 2.9 | 2.9 | | | |
| | Pigment paste | P-1 | 60 | 60 | 60 | 60 | 60 | 60 | 60 | 60 | 60 | 60 |
| | Deionized water | | 257 | 257 | 257 | 257 | 257 | 257 | 257 | 257 | 257 | 257 |
| Coating material solid content % | | | 20 | 20 | 20 | 20 | 20 | 20 | 20 | 20 | 20 | 20 |
| Evalua- | Water resistance | | ◯ | ◯ | ◯ | ◯ | ◯ | X | X | Δ | Δ | X |
| tion | Solvent resistance | Xylene | ◯ | ◯ | ◯ | ◯ | ◯ | ◯ | Δ | ◯ | ◯ | Δ |
| test | | Methyl ethyl ketone | ◯ | ◯ | ◯ | ◯ | ◯ | Δ | Δ | ◯ | ◯ | Δ |
| | | Ethanol | ◯ | ◯ | ◯ | ◯ | ◯ | Δ | Δ | ◯ | ◯ | Δ |
| | Adhesive property | | ◯ | ◯ | ◯ | ◯ | ◯ | Δ | Δ | ◯ | ◯ | Δ |

| | | | | | | | | | | |
|---|---|---|---|---|---|---|---|---|---|---|
| Salt spray test | ◯ | ◯ | ◯ | ◯ | ◯ | X | X | X | X | X |

According to the present invention, an epoxy-modified urethane resin having more functional groups is obtained by reacting polyurethanepolyol having a carboxyl group with an epoxy compound to introduce a secondary hydroxyl group into the resin skeleton. Combination of the above resin with a curing agent makes it possible to form a minute cross-linked coating film having a good curing property and obtain a coating film which is excellent in performances such as a solvent resistance, a water resistance and an adhesive property while having performances such as flexibility and toughness provided by polyurethane.

1. A resin composition for a coating material comprising an epoxy-modified polyurethane resin (A) obtained by reacting a carboxyl group-containing polyurethanepolyol resin obtained by reacting an isocyanate compound (a) and a polyol (b) with a hydroxycarboxylic acid (c) with an epoxy compound (d) in such a proportion that the epoxy group falls in a range of 0.1 to 1 equivalent per equivalent of the carboxyl group and a curing agent (B).

2. The composition as described in claim 1, wherein the isocyanate compound (a) is an aliphatic or alicyclic diisocyanate compound.

3. The composition as described in claim 1, wherein the polyol (b) is a diol having a number average molecular weight falling in a range of 62 to 10,000.

4. The composition as described in claim 1, wherein the hydroxycarboxylic acid (c) is selected from the group consisting of 2,2-dimethylolpropionic acid, 2,2-dimethylolbutyric acid, 2,2-di-methylolvaleric acid, hydroxypivalic acid and hydroxyisobutyric acid.

5. The composition as described in claim 1, wherein the carboxyl group-containing polyurethanepolyol has a number average molecular weight falling in a range of 600 to 30,000.

6. The composition as described in claim 1, wherein the carboxyl group-containing polyurethanepolyol has an acid value falling in a range of usually 5 to 150 mg KOH/g and a hydroxyl group value falling in a range of 10 to 330 mg KOH/g.

7. The composition as described in claim 1, wherein the epoxy compound is a compound having 1 or 2 epoxy groups in a molecule.

8. The composition as described in claim 1, wherein the epoxy-modified polyurethane resin (A) has a primary hydroxyl group falling in a range of 5 to 300 mg KOH/g based on the resin solid matter.

9. The composition as described in claim 1, wherein the epoxy-modified polyurethane resin (A) has a secondary hydroxyl group falling in a range of 5 to 150 mg KOH/g based on the resin solid matter.

10. The composition as described in claim 1, wherein the epoxy-modified polyurethane resin (A) has a weight average molecular weight failing in a range of 5,000 to 200,000.

11. The composition as described in claim 1, wherein the curing agent (B) is selected from the group consisting of a melamine curing agent and a blocked isocyanate curing agent.

12. A coating material composition comprising the resin composition for a coating material as described in claim 1.

13. An electrodepositable coating material comprising the resin composition for a coating material as described in claim 1.
